(19) United States
(12) Patent Application Publication
(10) Pub. No.: US 2002/0128909 A1
(43) Pub. Date: Sep. 12, 2002

(54) Method of providing managers an opportunity to own their own businesses

(76) Inventors: David Scrivano, Howell, MI (US); Eric A. Castiglia, Sterling Heights, MI (US); R. Brett Yates, Livonia, MI (US); Steven D. King, Superior Township, MI (US); Robert Mazziotti, Northville, MI (US)

Correspondence Address: DICKINSON WRIGHT PLLC, 1901 L Street, N.W. Suite 800, Washington, DC, 20036, US

(21) Appl. No.: 10/036,415

(22) Filed: Jan. 7, 2002

Related U.S. Application Data
(60) Provisional application No. 60/259,703, filed on Jan. 5, 2001.

(51) Int. Cl. G06F 17/60

(52) U.S. Cl. 705/14; 705/35

(57) ABSTRACT

The present invention relates to a method wherein a manager is selected to manage a business or franchise leading to ownership thereof. The method preferably comprises determining the cost of purchasing the business or franchise and screening the manager candidate to determine whether the candidate can qualify for a loan on the amount of financing required to purchase the business or franchise. The method also preferably comprises incentives to increase performance and the value of the business, wherein bonuses and/or discounts that can be applied toward the purchase can be earned. The method preferably comprises providing financing to allow the manager to buy the business or franchise at the end of a predetermined amount of time, wherein the cost of purchasing the business or franchise is reduced by the discounts earned by the manager during the predetermined amount of time. The preferred method involves the cost of purchasing the business or franchise being substantially fixed in advance as an incentive for the manager to work hard to increase the value of the business during the predetermined amount of time.

### RELATED APPLICATIONS

This application is entitled to the benefit of the filing date of U.S. Provisional Application, Serial No. 60/259,703, which was filed on Jan. 5, 2001.

### FIELD OF THE INVENTION

The present invention relates to the field of business methods, and in particular, to a method of providing an opportunity to a manager of a business to become an owner thereof.

### BACKGROUND OF THE INVENTION

In the fast food and quick serve restaurant business, it is often difficult to find quality managers that are willing to manage the business and commit themselves for the long term. The nature of the work, as well as the salaries and long hours, often make it difficult to attract and maintain quality management. Yet, in the competitive marketplace, it is vitally important that managers, in particular, be fully committed to the growth and future of the business that they manage, to enable it to thrive and meet the demands of the market.

Many franchises of national franchise chains are owned by individuals. Ownership imparts a personal responsibility that serves as an incentive to the owner to contribute time, effort and money to the business. In this respect, many of the largest national restaurant chains provide opportunities for franchise ownership, wherein the owner(s) operate the franchise as a small business. While franchise fees are imposed, the incentive is for the owner to “be his own boss” and obtain a significant portion, if not all, of the profits. This is often a significant incentive for managers/owners to put in the time and effort needed to make the business successful.

For individuals to own a franchise, however, a significant investment of capital is often required. While many people entertain the idea of someday owning their own franchises, many are often disappointed due to the inability to obtain the money or financing needed to buy the franchise. This not only precludes people from owning their own franchises, but the franchisor is then also disadvantaged by the difficulty of having to find motivated, quality individuals to manage the businesses.

What is needed, therefore, is a method that provides incentives to managers of a business that leads to ownership thereof, wherein incentives are given for the manager's hard work and commitment, and discounts can be earned that can be applied toward the purchase price of the business.

### SUMMARY OF THE INVENTION

The present invention relates to a method of giving managers of businesses the chance to own their own businesses. One of the preferred applications of the method is in connection with national chain restaurants, such as pizza restaurant franchises, and other food service businesses, although it can be applied to virtually any type of business. The term “business” used throughout the discussion is intended to refer to businesses and/or franchises.

Under the program, the manager is preferably initially screened to ensure not only that he or she is qualified for the position, but also to determine whether he or she can pre-qualify for the loan that would be needed to purchase the business at the end of a predetermined amount of time. The manager is employed, trained, earns a salary, and is given an opportunity to earn bonuses and discounts, and, over a period of time, the possibility of 100 percent ownership of the business at a discounted price. With the program, the company that runs the business is able to obtain a recruiting advantage by providing high-performing, loyal managers the ability to be a franchise owner of the business that they have helped to build. The method allows qualified candidates an opportunity to become entrepreneurs, and the ability to be their own boss.

Initially, the company that operates the business preferably selects the right candidate for manager of a given location. The company preferably uses recruiting techniques designed to attract the best possible candidates. In this respect, the ability of the company to offer an opportunity for full ownership of a franchise within a relatively short period of time preferably provides an incentive to highly qualified individuals to apply for the positions.

The recruiting process preferably involves screening the candidates to determine job qualification and loan pre-qualification. Because the program is designed to enable managers to become owners of the business that they help to build, one unique aspect of the present method is that it preferably involves a loan pre-qualification step, such as in advance of employment into the program, including background and credit checks, to help ensure that the manager will be able to qualify for the loan at the appropriate time. This could involve, for example, making a determination of the approximate value of the business that is to be purchased in advance of employment. The candidate may also be required to show that he or she is able to pay a deposit that will be required to be paid in advance of the program. Also, at the time of purchase, the loan is preferably offered and financed by the company that operates the business, or, if the business is not owned by the company, the franchisee, on behalf of the manager. This way, the manager will not be required to search and obtain approval for outside financing which can be difficult.

Once the candidate is chosen, the company preferably trains the candidate to become an effective manager and eventually an owner. The candidate is also preferably required to pass an examination to ensure that he or she is prepared for the program. Other qualification measures, such as interviews and other training and tests during the program, can also be applied.

A unique aspect of the present method is that the purchase price is preferably determined and fixed at the beginning of the program. This way, the manager will know at the outset how much money will be required to buy the business, and the price will not be increased as a result of building the value of the business. In such case, the manager has an incentive to increase sales and build the value of the business, which can be based on past sales, during the course of the program, as opposed to having an incentive to keep the value of the business relatively low (so as not to drive the purchase price up).

The candidate is preferably required to pay a deposit that can be applied toward the purchase price of the business before starting the program. The company can also set up a savings account to help pay start-up and operating costs associated with the business, wherein the company can match, either fully or partially, the contributions of the manager, i.e., to pay for operating and/or renovation costs, etc. The candidate is also preferably allowed to select which business location he or she wants to manage and own.

The program preferably includes several incentives to the manager to increase performance, wherein the manager has the opportunity to earn bonuses and discounts that can be applied toward 1) the purchase price of the business, 2) the franchise fee, and/or 3) the costs associated with renovating the property. For example, the method can involve enabling bonuses and discounts to be earned based on meeting certain percentage increases in sales and/or profits during the program. These incentives are preferably designed to encourage the manager to work hard and be committed to the business, and to putting in the time and effort needed to make the business successful, which in turn, can increase the value of the business. The company benefits from an increase in sales, and subsequently, after increasing sales, greater royalties.

Salary and period-end bonuses can also be given as an incentive for performance. For example, a period-end bonus that is based on a percentage of the profits earned by the business during any given period, such as weekly, monthly, quarterly, yearly, etc., can be provided. A straight salary bonus based on sales during any preceding period can also be provided. In this respect, additional bonuses to provide incentives for performance can be provided by virtually any means available.

The preferred program contemplates that certain performance criteria and/or standards be satisfied for bonuses and discounts to apply. For example, the bonuses and discounts, or the degree to which they apply, can be made dependent on whether the manager is able to keep food, paper and labor costs within certain targeted goals. They can also be dependent on being able to avoid cash shortages and making sure that daily runs to the bank are accomplished by a predetermined time. Both objective and subjective criteria to enforce compliance can be used. The company can also consider whether the manager has met certain requirements relating to cash flow and keeping the business cash flowing as a condition of ownership, wherein the manager can be required to meet these requirements before being allowed to purchase the business at the end of the program. The company also preferably monitors the manager's progress and provides support for the business.

Once the manager has satisfied the performance criteria and/or standards, met the cash flow expectations, and has completed the program to the company's satisfaction, the manager is preferably given a chance to buy the business from the current owner. In this respect, near the end of the program, the company preferably conducts additional credit checks and has the manager qualify for the loan again, but this time at the discounted price. The manager preferably is given an opportunity to purchase the business at the fixed purchase price, minus any discounts that have been earned by the manager during the program.

The method preferably enables the company to maximize results by using incentives to increase performance. The net effect of the program is to obtain high quality personnel, reduce turnover and related training costs, and give multi-business owners a vehicle by which to attract and retain high quality management. The program also provides a method for current franchise owners to sell their businesses, and helps to encourage managers to reach their potential.

### DETAILED DESCRIPTION OF THE INVENTION

The present invention relates to a method that provides incentives to managers who can work and earn bonuses and discounts towards the purchase of the business that they are managing. The method involves placing the manager in a salaried plan and having him/her manage the business for a predetermined amount of time, wherein the manager can earn performance and/or time-based bonuses and/or discounts that can be applied towards the purchase of the business. This way, at the end of the program, i.e., a predetermined amount of time, specific financing terms can be offered to the manager, whereby the manager can then purchase the business and obtain the benefits of ownership, including a substantial portion, and potentially all, of the profits. This plan has the effect of enabling the company to attract and retain high quality managers, increase sales and market share, and train managers to have an ownership mentality.

In a preferred method of the present invention, the manager candidate is screened and required to pre-qualify in advance for the loan that will be required to purchase the business. Also, in the preferred embodiment, the initial purchase price of the business is determined and substantially fixed prior to the manager starting the program, wherein the discounts that the manager earns during the program can be applied toward the purchase price at the end of the program. In this respect, the manager is preferably given an incentive to work hard and be committed to the business in order to increase sales, and therefore, boost the value of the business.

The present method is particularly suited to national chain restaurants, including fast food and quick serve restaurants, which are common among pizza chains. These businesses tend to provide challenges that require highly motivated and committed managers, but without the ability to provide the most attractive financial and status rewards. The present plan is intended to overcome these disadvantages, by providing incentives to prospective managers and encourage them to stay committed to the businesses that they manage, which in turn, can provide benefits to the company. The term “managers” is intended to include any person that could bring value to the business, including supervisors, trainers and other employees that could be hired to work toward ownership of the business.

The method preferably comprises selling a particular business to the manager that is managing it, under specific terms designed to increase performance and sales, as well as the value of the business. The business that is to be sold can be owned by the company that operates the national chain, or by individual franchisees who are looking to sell their franchises. The method can also be applied to newly created businesses that are developed and/or constructed specifically for the program.

The initial step is preferably to determine which businesses would be appropriate for the program. This decision can be based on the past history of the particular business, i.e., how well or how poorly it has done in the past. The typical existing property that would be ideal for the program is one that is believed to have unmet potential, wherein the reason could be attributed to poor management in the past. This might, for example, be a franchise located in an area that has good economic conditions, where there is little competition for that business, and/or where traffic is relatively high, wherein the expectations would be that with good management it could achieve better operating results.

Choosing the right candidate for manager is also important to the successful implementation of the program. This involves not only applying recruiting techniques designed to attract the best possible candidates, but also the ability to offer to the candidates an opportunity for full ownership in a franchise within a relatively short period of time, which can provide an incentive for the best candidates to apply.

The recruiting steps can initially involve conventional recruiting techniques such as those practiced by the industry. For example, the recruiting process can involve a screening process using a preset criteria to ensure that the appropriate candidates are identified. This may involve, for instance, a telephone interview between the applicant and owner or franchiser of the business, wherein a list of predetermined questions for the applicant to answer could be asked. The first interview could be conducted on the telephone, and then be followed by an invitation to a personal interview with the owner or franchiser after the candidate passes the first interview. Those who make the hiring decisions would then have a chance to personally interview the candidate and determine whether the candidate qualifies for the program. While one method involves hiring brand new managers, another method involves hiring managers in designated existing businesses or franchises to become involved in the program, i.e., by passing the same interview process, subject, of course, to any evaluations that may need to be made based on past performance.

Because the program is designed to enable managers to become owners of the businesses that they work for, one unique aspect of the recruiting step is that it preferably involves a screening process relating to the candidate's ability to pre-qualify for the loan to purchase the business. In this respect, the process preferably involves the owner or franchiser conducting credit and background checks, as well as having the candidate fill out loan applications, and having an investigation done in an effort to determine whether the candidate would be able to obtain financing at the appropriate time. An advanced determination of the expected purchase price of the business is also preferably made for this purpose. The process may also involve determining whether the candidate would be able to pay a deposit in advance, such as by confirming that the candidate has sufficient liquid assets, which can be applied toward the purchase of the business, if and when the business is purchased.

Upon selection of the manager candidate, the owner or franchiser of the business would then train the individual to become a manager. Various classes, which can be paid for by the company, are preferably given before and during the program to help train the individual to become an effective and knowledgeable manager. Unlike other ownership programs, the present method contemplates that the training would be provided and paid for by the company. The classes are preferably designed to provide training relating to the operation of the business, including topics such as cash flow analysis, taxes, legal, accounting, loss prevention, human resources, real estate, lease negotiation, marketing, customer service, corporate communications, etc. The method also preferably requires the candidate to pass certain training examinations to ensure that the candidate is prepared for the program.

The company may preferably set up a savings account that could be used to help pay for start-up and operating costs associated with the business. The candidate is preferably invited to participate in the savings account and given a chance to contribute, such as via payroll deduction, a certain percentage of income into the account during the program. The owner or franchisor can also opt to match, either fully or partially, the contributions of the manager, to assist in developing an account appropriate for the business. The money in the savings account can be used to pay for operational expenses and improvements to the business, such as renovating the property at the desired time.

The length of the program from start to finish, i.e., from the time the manager begins the program to when the manager purchases the business, is preferably within the range of six months to five years. The actual time of the program for each particular candidate is preferably within the discretion of the company. When the length of the program is relatively short, it is contemplated that the candidates would have to be very carefully screened, and have substantial past experience in operating businesses of the same kind. The goal, in such case, would be for the manager to be able to make an immediate impact on the business, to help increase sales and add value to the business, wherein only a few months under the program would be needed for the manager to be ready to own the business.

On the other hand, for candidates that are not quite as promising, or do not have the necessary experience, as well as existing managers who have worked for several years but have been unable to purchase their own franchises, it is contemplated that a longer program could be implemented. This preferably enables the company to monitor and review the manager's performance and progress, and allow time for the manager to gain experience and knowledge, which can help ensure that the manager is qualified to take over as an owner at the end of the period. This additional length of time enables the company to see how the manager performs and responds to the incentives and standards that are set out by which to judge performance. This also helps ensure that the candidate is fully committed to developing and growing the business.

During the program, the manager is preferably employed by the company (or franchisee if not the company) and receives a salary. Also, unlike previous ownership programs, the manager preferably receives employee benefits of the company during the program, including health plans, participation in retirement plans, workers compensation, etc. Once the manager becomes an owner, however, the manager/owner would preferably then become responsible for his or her own benefits.

A unique aspect of the present invention is that the program allows for the purchase price of each business to be determined and substantially fixed at the beginning of the program. That is, the purchase price of the business is preferably fixed before the manager begins the program, wherein the manager will know at the outset how much money will be needed to buy the business from the current owner. While the purchase price is preferably fixed, the present invention contemplates that the price can be “substantially” fixed, i.e., within a certain range, and subject to any discounts, as will be discussed, if desired. The present invention also contemplates that the purchase price can be substantially fixed sometime during the program, i.e., after two years of a five year program.

The purchase price, in such case, is preferably based on the then existing value of the business, which can be determined by volume of past sales of that business. For example, the purchase price can be determined by using one of the following formulas: 50% of the last two years average annual sales, or 40% plus the franchise fee. Other formulas that attempt to determine the value of the business can also be used and are within the scope of the invention. The purchase price is preferably subject to approval of the company.

The benefit of setting the purchase price in advance is that the manager can be inducted into the program knowing what the purchase price will be, i.e., it can serve as a target to shoot for. Knowing the purchase price also allows for the loan pre-qualification step to take into account the actual expected purchase price of the business. The purchase price in this context can mean the price of the business, plus any other costs associated with the purchase, such as the franchise fee, etc.

At the same time, the manager will have an incentive to work hard to increase sales and meet the performance criteria and/or standards set by the company, so that the manager can obtain the maximum discounts that can be applied to the purchase price at the end of the program. Without setting the purchase price in advance, the manager would be in the difficult position of having to work hard to increase the value of the business, which would then result in driving up the purchase price, so that by the time the manager is able to purchase the business, the price will have been increased by his own efforts. By fixing the purchase price in advance, the manager will know how much he or she would have to pay for the business, wherein the manager would then have a real incentive to put in the time and effort needed to increase the value of the business, and in turn, obtain discounts that can be applied toward the purchase price.

Some of the formalities that may be required to operate the program successfully include requiring the manager to pay a deposit at the beginning of the program. The deposit can be required up-front, or as part of a payment plan during the program period. In the preferred program, an initial deposit is paid up-front, and a one-time final payment is made at the end of the program to exercise the option and purchase the business. The deposit helps to pay for the administrative costs associated with the program, and also ensures that the candidate is committed to the program, and is willing to do what is necessary to complete the program. The deposit is preferably applied towards the franchise fee, or purchase price of the business, but is otherwise non-refundable (such as if the manager quits the program before finishing).

An agreement is preferably executed between the company (and/or franchisee if not owned by the company) and the manager to set forth the terms of the program. The agreement is designed to contractually bind both parties, and preferably includes the fixed purchase price, the predetermined period of the program (before the business can be purchased), the salary, the incentives (including bonuses and/or discounts that can be earned during the program), performance criteria and/or standards, etc. It can also set forth information relating to the financing to be provided by the company (or owner if not the company).

As part of the preparations for the program, the company can discuss certain choices with the manager, such as where the manager would like to work, the location of the business that the manager will be working to own, etc. This process can involve providing a list of designated locations that are available, and the candidate making a selection based upon having been given a chance to review the information about the location and/or visit the property. The company preferably provides information about each location, including its sales history, fixed costs, utility expenses, operating requirements, etc., if available. When a brand new location is created, the company preferably provides information that is available about the location, such as why the company chose to develop the property and the economic conditions of the area.

The program preferably includes several incentives that can be performance and/or time based. The manager preferably has the opportunity to earn discounts that can be applied toward 1) the purchase price of the business, 2) the franchise fee, and/or 3) the costs associated with renovating the property. For example, the discounts can be made applicable based on a percentage of increase in sales achieved by the business that the manager is managing. This can be based, for instance, on increases in sales during a predetermined amount of time, i.e., every month, quarter, year, etc. When a brand new business is involved, the increase can be calculated with respect to each preceding period.

The amount of the discount can be dependent upon the percentage of sales increases achieved by the business during the preceding period. For example, the discount could involve a discount of $3,000 for every 10% increase in sales generated by that business, up to a maximum of $15,000 for a 50% or more increase in sales by the end of the program. The discounts can also be weighted in favor of proportionally rewarding a relatively high percentage increase in sales, by providing a relatively small discount for the first 10% to 20% increase in sales, while providing a much larger discount for achieving 30%, 40% and 50% increases. Likewise, if it is desirable to provide incentives for smaller increases in sales, the discounts can be weighted in favor of offering more discounts when achieving a 10% to 20% increase in sales. In this respect, the amount of the discounts, and how the manager obtains them, can be established by the company to promote or engineer a desired result, depending on the circumstances.

In another example, it may be practical to change the percentages from period to period, such as on a straight line curve, i.e., from year to year. For example, the company may want to establish an incentive program where a 10% increase in sales every year (over the preceding year) will result in an additional 5% discount toward the purchase price, i.e., for each year that the manager participates in the program. This way, by the end of the fifth year, if the manager has met the performance incentives, he or she may be entitled to a 25% discount on the purchase price.

These performance based discounts can be applied to any of the costs associated with the purchase of the business, including the purchase price, franchise fee, renovating costs, etc. The same type of incentives can be provided for each cost item, or different incentive criteria can be applied to each one. In the preferred embodiment, the program allows the manager to obtain a maximum of 75% off the franchise fee, while it may only allow a maximum of 25% off the purchase price. That is, a manager may be able to obtain as much as 75% off the franchise fee, which is typically much less than the purchase price, whereas, the maximum amount that the purchase price may be discounted may be considerably less, i.e., 25% or less. All of these numbers are exemplary, and by no means intended to be limiting.

Additional discounts can also be applied to the cost of renovating the property, i.e., re-imaging. These discounts can be given in the same manner discussed above. Also, a savings plan can be set up in advance whereby contributions can be made by the manager during the course of the program which can be used to pay for the costs. The company, in such event, can match, either dollar for dollar, or some percentage for each dollar, such as 50 cents, the amount contributed by the manager, as a means of giving the manager an incentive to contribute to the account. Whether the funds are matched, and the extent of the matching funds, could be based on performance, as well as meeting certain criteria, as a means of providing an incentive for the manager to work hard and increase sales.

The discounts can also be time based. That is, for longer term programs, the extent of the discounts can simply be based on how long the manager has been employed in the program. For example, the discount that can be earned may be 5% for each year that the manager participates in the program. A combination of performance and time based discounts can also be given, i.e., the rewards for meeting certain performance criteria can increase over time.

The following is an example of a plan where discounts on the franchise fee and purchase price are based on a percentage of increases in sales that are achieved by the business.

| Sales Increase Achieved | 5-9% | 10-4% | 15-19% | 20-24% | 25-29% |
|---|---|---|---|---|---|
| Purchase Price | $62,400 | $62,400 | $62,400 | $62,400 | $62,400 |
| (Sales × 40%) | | | | | |
| Franchise Fee | $20,000 | $20,000 | $20,000 | $20,000 | $20,000 |
| Option and Administration | ($5,000) | ($5,000) | ($5,000) | ($5,000) | ($5,000) |
| Fees Paid | | | | | |
| Non-Discounted Sales | $77,400 | $77,400 | $77,400 | $77,400 | $77,400 |
| Price | | | | | |
| Franchise Fee Discount | $0 | $0 | ($1,000) | ($3,000) | ($5,000) |
| Purchase Discount | ($6,240) | ($9,360) | ($12,480) | ($15,600) | ($15,600) |
| Total Discounts | ($6,240) | ($9,360) | ($13,480) | ($18,600) | ($20,600) |
| Purchase Price | $71,160 | $68,040 | $63,920 | $58,800 | $56,800 |
| Manager Down | ($10,674) | ($10,206) | ($9,588) | ($8,820) | ($8,520) |
| Payment (15%) | | | | | |
| Financed Purchase | $60,486 | $57,834 | $54,332 | $49,980 | $48,280 |
| Price | | | | | |
| Sales Increase Achieved | 30-34% | 35-39% | 40-44% | 45-49% | 50+% |
| Purchase Price | $62,400 | $62,400 | $62,400 | $62,400 | $62,400 |
| (Sales × 40%) | | | | | |
| Franchise Fee | $20,000 | $20,000 | $20,000 | $20,000 | $20,000 |
| Option and Administration | ($5,000) | ($5,000) | ($5,000) | ($5,000) | ($5,000) |
| Fees Paid | | | | | |
| Non-Discounted Sales | $77,400 | $77,400 | $77,400 | $77,400 | $77,400 |
| Price | | | | | |
| Franchise Fee Discount | ($7,000) | ($9,000) | ($11,000) | ($13,000) | ($15,000) |
| Purchase Discount | ($15,600) | ($15,600) | ($15,600) | ($15,600) | ($15,600) |
| Total Discounts | ($22,600) | ($24,600) | ($26,600) | ($28,600) | ($30,600) |
| Purchase Price | $54,800 | $52,800 | $50,800 | $48,800 | $46,800 |
| Manager Down | ($8,220) | ($7,920) | ($7,620) | ($7,320) | ($7,020) |
| Payment (15%) | | | | | |
| Financed Purchase | $46,580 | $44,880 | $43,180 | $41,480 | $39,780 |
| Price | | | | | |

In this example, the initial purchase price is $62,400, and the franchise fee is $20,000. The maximum discount given on the franchise fee is $15,000, and the maximum discount given on the purchase price is $15,600, based on achieving at least a 50% increase in sales over the predetermined period. Lesser discounts are achieved based on smaller increases. The discount amounts are dependent on the amount of the increase, i.e., from 5% to 50%, as seen in the chart. In this particular case, most of the discount for the franchise fee is applied on increases of 25% or more, while all of the discount on the purchase price is applied on increases of 20% or less. The chart shows that the initial fixed purchase price to buy the business at the end of the program is $77,400 (including a fixed purchase price of $62,400, plus a franchise fee of $20,000, minus a deposit of $5,000). The discounted cost of purchase, by achieving an increase of 50% or more in sales, is $46,800, or a discount of $30,600. The discounted cost by achieving an increase of 20% in sales is $58,800, including a discount of $18,600. In this example, a downpayment of 15% has been required for the financing. This is an example of a plan, and is by no means intended to be limiting.

Salary and period-end bonuses can also be given by the company to the manager. For example, a period-end bonus based on a percentage of profits earned during any given period can be provided. These periods can be weekly, monthly, quarterly, yearly, etc. The bonuses can be based on a percentage that is either fixed during the duration of the program, or increased/decreased during the life of the program. A simple salary bonus based on the amount of sales during any preceding period can also be provided. For example, for every $1,000 of sales in excess of $5,000 during any given period, such as weekly, the manager can be given a bonus. The bonus can be a predetermined amount, i.e., $50 for every $1,000 in sales above a predetermined amount.

The program also contemplates that the bonuses and/or discounts be given, and/or adjusted, depending on whether certain performance criteria and/or standards have been satisfied. For example, any one of the bonuses and discounts discussed above can be made dependent on whether the manager is able to comply with or satisfy criteria such as the following:

a. Keeping food and paper costs within certain targeted goals (of the charted costs set by the owner of the business). One way to apply this criteria is to require that any percentage over the minimum expended by the business will be assigned a dollar amount and then deducted from the bonuses and/or discounts given to the manager.

b. Keeping labor costs within certain charted man-hours set by the owner. This criteria can be applied to man-hours for any given period which can be multiplied by the average hourly wage and the dollars deducted from the bonuses and/or discounts.

c. Any cash shortages that may occur in the business during the period can be deducted from the bonuses and/or discounts.

d. The company can require the manager to conduct daily runs to the bank by a predetermined time, i.e., by 11:00 a.m., as an incentive to get the money into the bank at the earliest possible time every day. This incentive can be designed with a penalty for any given day that the bank run is not done by that time, which can be deducted from the bonuses and/or discounts.

These performance criteria and/or standards can be either objective or subjective. Objective criteria can involve, for example, a checklist of multiple items that the manager must do every day, every week, every month, etc., wherein penalties can be assigned for non-performance of any of those items. The checklist can include items such as the minimum number of hours (and dollars) that must be spent conducting marketing efforts. For more subjective criteria, the company may want to conduct a customer survey to determine customer satisfaction. In such case, the responses that are given could be the basis for either increasing or decreasing the bonuses and/or discounts.

The present invention also contemplates that the company can consider whether the manager has met certain requirements relating to cash flow and keeping the business cash flowing during the program in determining whether the manager has satisfied the performance requirements and is entitled to purchase the business. The determination of whether the manager has met the minimum requirements can be based, for example, on whether and to what extent the business is cash flowing during any period during the program, such as monthly, quarterly, semi-annually, annually, etc. The ability of the manager to achieve these expectations can be made a condition of the purchase of the business. This way, the manager would have an incentive to work hard to meet the expectations, and the company will have a mechanism by which to disqualify poor managers who are not willing to work hard.

It is contemplated that the company would provide support for the manager in the every-day tasks relating to the business. For example, the company can provide all of the necessary supplies and equipment, including printed graphics and advertising which can be used for store displays, newspaper and magazine advertisements, etc. Specific training and course manuals for all employees of the business can also be provided by the company. Opportunities for managers to contribute to local and regional radio and television advertisement programs can also be provided.

The company may also require an existing franchisee to spend a certain amount of money on re-imaging costs associated with renovating the property. This can be done, for example, in conjunction with the contributions by the manager made to the savings account, and is preferably done during the program period.

The company preferably continually monitors the progress of the manager in meeting the performance criteria and/or standards. When expectations fall short, the company can increase its support and efforts to provide the means necessary for the manager to continue to meet the needs of the business. Various factors are preferably considered by the company in deciding whether certain performance criteria are satisfied, including the location of the property, the competition in the area where the property is located, the economic condition of the area, the crime rate, the availability of honest, hard-working employees, etc.

Once it is determined that the manager has satisfied the performance standards and/or criteria, met the profit expectations, and has completed the program to the satisfaction of the company, the manager is preferably given a chance to buy the business. Near the end of the program period, the company (or owner if not the company) preferably begins procedures for providing financing to the manager. Additional credit checks and loan qualification steps are preferably performed to insure that the manager is still able to qualify for the financing. The final purchase price including the franchise fee required to be paid by the manager to buy the business is preferably determined based on the fixed purchase price, and the amount of discounts that have been earned. The total amount is preferably based on this discounted price, wherein the manager would, in the preferred embodiment, be given an opportunity to buy 100% ownership in the business at the discounted price. The financing is preferably for the discounted amount, as well as interest and closing costs, and includes a term for payments to be made. A downpayment on the cost of the purchase may also be required as part of the financing terms.

Once the financing is approved, plans are preferably put into effect to set a final transfer date, and to have the manager sign the necessary documents, including financing papers, and the franchise agreement. Certain license transfers, such as those involving the city, the state, the health department, etc., are also preferably provided.

Alternative embodiments of the program could involve the manager becoming only a partial owner of the business, which can be dependent upon how successful the manager has been in meeting the performance criteria and/or standards during the program. For example, the terms of the program could specify that if certain performance criteria and/or standards are not met during the period, the manager could only purchase a partial ownership interest, which may be necessary for the company to protect its interests.

The present invention also contemplates that the company can implement and use the method as a recruiting means to attract other quality personnel to the company. That is, the invention contemplates that the company can, by promoting the method, generate positive publicity for the company, which in turn, could be used to attract personnel to other levels within the company, not just managers. For example, the positive publicity generated by the method can be used as a means of attracting new employees or owners of franchises who have the necessary experience and/or the financial capital needed to purchase the businesses outright. In such case, the method can be used to attract individuals to the company who would not necessarily be required to go through the program to become owners of the businesses.

The present invention also contemplates that the method could be used in connection with selecting and hiring individuals who are not employed to be managers of the business. In this respect, the method could be used to attract quality supervisors, trainers, etc., or any other employee or person that would bring value to the business. The term “manager,” in such case, which is used throughout, is intended to include any employee or person that could provide value to the business. In such case, the method contemplates selecting and hiring individual employees who would be able to qualify for the program, and in turn, be given an opportunity to own, either partially or fully, the business within a predetermined amount of time, but without full management responsibilities.

What is claimed is:

1. A method of providing incentives to managers for managing a business leading to ownership thereof, comprising:
selecting a candidate to serve as a manager of the business;
setting a predetermined amount of time before the manager can purchase the business;
setting the initial purchase price of the business in advance of the purchase;
allowing for the reduction of the initial purchase price and/or franchise fee based on discounts earned by the manager during the predetermined amount of time; and
allowing the manager to buy the business at the end of the predetermined amount of time, wherein the final purchase price is based on the initial purchase price and/or franchise fee minus the amount of discounts earned by the manager.

2. The method of claim 1, wherein the recruiting step comprises requiring the candidate to pre-qualify for financing on the initial purchase price of the business before the predetermined amount of time begins.

3. The method of claim 1, wherein the manager is required to pay a deposit at the beginning of the predetermined amount of time, wherein the deposit can be applied toward the final purchase price of the business.

4. The method of claim 1, wherein the manager can earn a salary plus one or more discounts based on performance and/or time that can be applied toward the final purchase price and/or franchise fee of the business.

5. The method of claim 4, wherein the initial purchase price of the business is determined prior to the predetermined amount of time and based on the value of the business at that time.

6. The method of claim 5, wherein the value of the business is determined on the basis of past annual sales of the business.

7. The method of claim 6, wherein the value of the business is determined on the basis of the past 2 years average annual sales of the business.

8. The method of claim 4, wherein the discounts to be applied to the purchase price and/or franchise fee are based on increases in sales and/or profits obtained by the business during the predetermined amount of time.

9. The method of claim 4, wherein the manager is employed during the predetermined amount of time and can earn one or more bonuses based on sales and/or profits earned by the business during any given period.

10. The method of claim 9, wherein the bonuses and/or discounts are dependent on the manager meeting certain performance criteria and/or standards.

11. The method of claim 1, wherein a savings account is set up into which the manager and/or owner of the business can contribute, and training is provided by the business to the manager.

12. The method of claim 1, wherein the financing is offered and provided to the manager by the owner of the business.

13. The method of claim 1, wherein the business is required to meet certain cash flow expectations as a condition of allowing the manager to purchase the business at the end of the predetermined amount of time.

14. A method of providing a manager of a business an opportunity to own the business that is being managed, comprising:
selecting a candidate to act as the manager of the business;
setting a predetermined amount of time before the manager can purchase the business;
determining the expected purchase price of the business and requiring the candidate to pre-qualify for financing, in advance of the predetermined amount of time, needed to purchase the business at the end of the predetermined amount of time;
providing incentives to the manager by allowing for the reduction of the cost of purchasing the business based on discounts earned during the predetermined amount of time; and
providing financing to allow the manager to buy the business at the end of the predetermined amount of time, wherein the cost of purchasing the business is reduced by the amount of discounts earned by the manager during the predetermined amount of time.

15. The method of claim 14, wherein the manager is required to pay a deposit at the beginning of the predetermined amount of time, wherein the deposit can be applied toward the cost of purchasing the business.

16. The method of claim 14, wherein the purchase price, upon which the advanced pre-qualification is based, is substantially fixed in advance of the predetermined amount of time.

17. The method of claim 16, wherein the substantially fixed purchase price of the business is based on the value of the business at that time, wherein the value of the business is determined on the basis of past annual sales of the business.

18. The method of claim 17, wherein the manager can earn a salary plus one or more discounts based on performance and/or time that can be applied toward the purchase price and/or franchise fee of the business at the end of the predetermined amount of time.

19. The method of claim 18, wherein the discounts to be applied to the purchase price and/or franchise fee are based on increases in sales and/or profits obtained by the business under the manager's management.

20. The method of claim 14, wherein the manager is employed by the business and can earn a salary plus one or more bonuses based on sales and/or profits earned by the business during any given period.

21. The method of claim 14, wherein the discounts are dependent on the manager meeting certain performance criteria and/or standards relating to cost control and cash flow measures.

22. The method of claim 14, wherein a savings account can be set up into which the manager and/or owner of the business can contribute.

23. The method of claim 14, wherein the owner of the business is required to renovate the business property at a predetermined time, subject to the manager meeting certain criteria.

24. The method of claim 14, wherein the business is required to meet certain cash flow expectations as a condition of allowing the manager to purchase the business at the end of the predetermined amount of time.

25. A method of implementing incentives for managing a business leading to ownership thereof, comprising:
providing for the selection of a candidate that can serve as a manager of the business;
providing for the setting of the purchase price of the business based on past performance of the business;
providing for the manager to be employed in a manner that enables the manager to earn one or more bonuses and/or discounts;
providing for the reduction of the purchase price of the business based on the bonuses and/or discounts that are earned; and
allowing for the manager to buy the business at the reduced price after a predetermined amount of time.

26. A method of providing a manager of a business an opportunity to own the business that is being managed, comprising:
selecting a candidate to act as the manager of the business;
setting a predetermined amount of time before the manager can purchase the business;
allowing the manager to work as a manager of the business during the predetermined amount of time;
providing incentives to the manager to earn discounts that can be applied toward the purchase of the business; and
providing financing to allow the manager to buy the business at the end of the predetermined amount of time, wherein the cost of purchasing the business is reduced by the amount of discounts earned by the manager during the predetermined amount of time.

27. The method of claim 26, wherein the candidate is required to pre-qualify for financing needed to purchase the business in advance of the predetermined amount of time.

28. The method of claim 27, wherein the purchase price, upon which the advanced pre-qualification is based, is substantially fixed before the predetermined amount of time begins.

29. The method of claim 26, wherein the manager is allowed to buy a business that is different from the one that the manager has been employed to manage.

30. A method of providing a manager/employee of a business an opportunity to own the business that is being managed, comprising:
setting a predetermined amount of time before the manager/employee can purchase the business;
determining and setting the purchase price of the business in advance of the predetermined amount of time;
allowing the manager/employee to work as a manager and/or employee of the business during the predetermined amount of time; and
providing financing to allow the manager/employee to buy the business at the end of the predetermined amount of time, wherein the cost of purchasing the business is based on the purchase price that has been set in advance.

31. The method of claim 30, wherein the manager/employee is required to pre-qualify for financing based on the purchase price in advance of the predetermined amount of time.

32. The method of claim 30, wherein the manager/employee can earn discounts that can be applied toward the purchase price of the business to reduce the cost of purchasing the business at the end of the predetermined amount of time.

33. A method of recruiting managers leading to ownership of a business, comprising:
providing for the selection of a candidate that can serve as a manager of a business;
providing for the setting of the purchase price of the business;
providing for the manager to be employed in a manner that enables the manager to earn one or more bonuses and/or discounts;
providing for the reduction of the purchase price of the business based on the bonuses and/or discounts that are earned; and
allowing for the manager to buy the business at a reduced price after a predetermined amount of time.
